(19) United States
(12) Patent Application Publication
(10) Pub. No.: US 2013/0027388 A1
(43) Pub. Date: Jan. 31, 2013

(54) APPARATUS AND METHOD FOR DOWNSIZING SURFACE ELEVATION DATA

(71) Applicant: Young Keun YOON, Chungbuk (KR)

(72) Inventor: Young Keun YOON, Chungbuk (KR)

(73) Assignee: Electronics and Telecommunications Research Institute, Daejeon (KR)

(21) Appl. No.: 13/438,378

(22) Filed: Apr. 3, 2012

(30) Foreign Application Priority Data
Jul. 26, 2011 (KR) 10-2011-0073902

(51) Int. Cl. G06T 15/00

(52) U.S. Cl. 345/419

(57) ABSTRACT

Provided is an apparatus and method for downsizing surface elevation data. The method includes receiving surface elevation data consisting of a plurality of cells, sequentially searching all the cells in a predetermined direction, comparing data of a cell having a predetermined reference elevation value or more with data of nearby cells, setting the cell as a boundary region when there is a nearby cell having different elevation data than the cell, grouping cells having the same data centered on the cell set as the boundary region, and performing triangulation on the basis of the grouping results. Since pieces of the same elevation data among pieces of high-resolution surface elevation data used in an outdoor environment are grouped as one, it is possible to carry out efficient analysis and improve analysis speed.

### CLAIM FOR PRIORITY

This application claims priority to Korean Patent Application No. 10-2011-0073902 filed on Jul. 26, 2011 in the Korean Intellectual Property Office (KIPO), the entire contents of which are hereby incorporated by reference.

### BACKGROUND

1. Technical Field

Example embodiments of the present invention relate in general to an apparatus and method for downsizing surface elevation data, and more particularly, to an apparatus and method for grouping pieces of the same elevation data among pieces of surface elevation data to downsize the surface elevation data.

2. Related Art

With the rapid development of virtual reality systems, computer games, etc., technology for three-dimensionally representing objects, terrain, etc. of the real world using a computer system have recently been researched and developed. A mesh model is a typical technique for representing the real world as a three-dimensional (3D) image in a computer.

The mesh model is a technique of representing an object or a 3D surface, such as terrain, consisting of a set of multiple triangles, rectangles, or polygons connected with each other. For a mesh model-based 3D representation of huge data such as large-scale terrain in a computer system, proper terrain generation, management, and representation techniques are required to effectively use limited graphic resources of the computer system. To this end, a progressive mesh (PM)-based technique, a digital elevation model (DEM) technique, a real-time optimally adapting mesh (ROAM) technique, etc. have been conventionally provided.

In particular, as a data format for representing elevation information on the terrain of a specific region, the DEM technique is a technique of dividing a target area into lattices of a predetermined size and numerically representing a continuous spatial fluctuation in the corresponding lattices. Objects, terrain. etc. of the real world are represented through polygon-based rendering using a DEM.

Meanwhile, the DEM technique can be used to generate a propagation model. Such a propagation model represents propagation characteristics of electric waves, and is used to estimate signal intensity according to a specific distance, location, terrain, and so on. For example, a propagation model can be used in the propagation environment of a downtown to area in which received power is dependent on a propagation environment between a base station and a mobile station. For accurate estimation of the received power, the propagation model needs to be precisely analyzed. However, a propagation model that is generated using entire pieces of elevation data of the ground as reflective objects requires a long analysis time.

### SUMMARY

Accordingly, example embodiments of the present invention are provided to substantially obviate one or more problems due to limitations and disadvantages of the related art.

Example embodiments of the present invention provide a surface elevation data downsizing method of grouping pieces of the same elevation data among pieces of surface elevation data to downsize the surface elevation data.

Example embodiments of the present invention also provide a surface elevation data downsizing apparatus for grouping pieces of the same elevation data among pieces of surface elevation data to downsize the surface elevation data.

In some example embodiments, a method of downsizing surface elevation data includes: receiving surface elevation data consisting of a plurality of cells, sequentially searching all the cells in a predetermined direction, comparing data of a cell having a predetermined reference elevation value or more with data of nearby cells, and setting the cell as a boundary region when there is a nearby cell having different elevation data than the cell; and grouping cells having the same data centered on the cell set as the boundary region, and performing triangulation on the basis of the grouping results.

In other example embodiments, an apparatus for downsizing surface elevation data includes: a search unit configured to sequentially search all cells in a predetermined direction on the basis of received surface elevation data consisting of the plurality of cells, compare data of a cell having a predetermined reference elevation value or more with data of nearby cells, and set the cell as a boundary region when there is a nearby cell having different elevation data than the cell; a grouping unit configured to group the same elevation data centered on the boundary region; and a processor configured to perform triangulation on the basis of the grouping results.

### BRIEF DESCRIPTION OF DRAWINGS

Example embodiments of the present invention will become more apparent by describing in detail example embodiments of the present invention with reference to the accompanying drawings, in which:

FIG. 1 illustrates elevation data in the Universal Transverse Mercator (UTM) coordinate system input to an apparatus for downsizing surface elevation data according to an example embodiment of the present invention;

FIG. 2 generally shows an internal structure of an apparatus for downsizing surface elevation data according to an example embodiment of the present invention;

FIG. 3 illustrates a method for a search unit of an apparatus for downsizing surface elevation data to compare data of a cell equal to or greater than a predetermined reference elevation value with data of nearby cells according to an example embodiment of the present invention;

FIG. 4 illustrates an example of a process in which a search unit of an apparatus for downsizing surface elevation data performs downsizing using a one-cell shift method according to a first example embodiment of the present invention;

FIG. 5 illustrates an example of a process in which a search unit of an apparatus for downsizing surface elevation data performs downsizing using a two-cell shift method according to a second example embodiment of the present invention;

FIG. 6 illustrates results of grouping centered on a boundary region by a grouping unit of an apparatus for downsizing surface elevation data according to an example embodiment of the present invention;

FIG. 7 illustrates results of triangulation performed by a processor of an apparatus for downsizing surface elevation data according to an example embodiment of the present invention; and

FIG. 8 is a flowchart illustrating a method of downsizing surface elevation data according to an example embodiment of the present invention.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” with another element, it can be directly connected or coupled with the other element or intervening elements may be present. In contrast, when an element is referred to as being “directly connected” or “directly coupled” with another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the present invention will be described in detail with reference to the appended drawings.

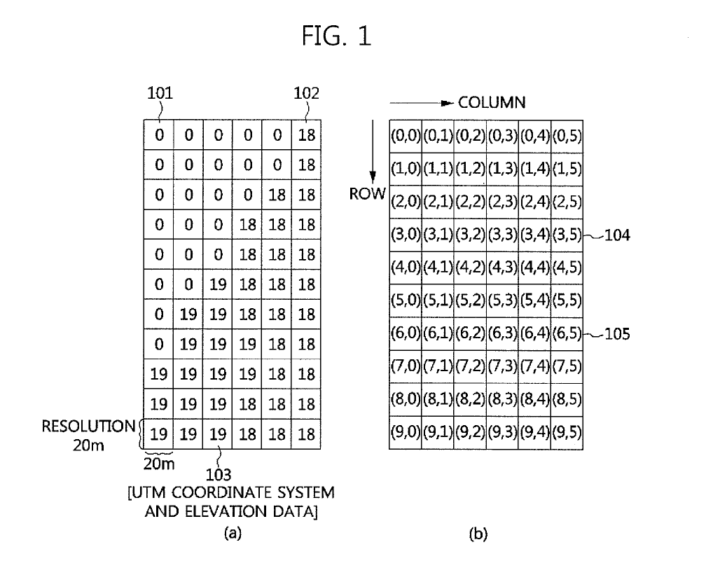

FIG. 1 illustrates elevation data in the Universal Transverse Mercator (UTM) coordinate system input to an apparatus for downsizing surface elevation data according to an example embodiment of the present invention.

FIG. 1(a) illustrates elevation data in the UTM coordinate system, and FIG. 1(b) illustrates an internal structure of elevation data in the UTM coordinate system.

Referring to FIG. 1(a), cell configuration of elevation data is based on the format of UTM coordinate system zone 52. The UTM coordinate system is a grid coordinate system for representing positions of points on the whole Earth in a uniform manner. In the UTM coordinate system, the whole Earth is divided into 60 zones that are numbered 1 to 60 and six degrees of longitude wide, and in each zone, coordinates on an ellipsoid are converted into coordinates on a plane. Also, area from 80 degrees north latitude to 80 degrees south latitude of the Earth is divided at intervals of eight degrees of latitude wide and lettered starting from C to X, excluding the letters I and O, and in each zone, coordinates on the ellipsoid are converted into coordinates on a plane. In the UTM coordinate system divided into zones as described above, South Korea is in longitude zones 51 and 52 and latitude zones S and T.

Therefore, description of the present invention will be made on the basis of the format of UTM coordinate system zone 52. In the format of UTM coordinate system zone 52, each cell has a resolution of 20 m×20 m and its own elevation data. Elevation data represents a vertical distance from the ground to a point or surface, that is, a height from the ground or a height above ground, in number. For example, elevation data “0” 101 denotes a height of 0 m above ground, that is, the surface, elevation data “18” 102 denotes a height of 18 m above ground, and elevation data “19” 103 denotes a height of 19 m above ground.

Referring to FIG. 1(b), the internal structure of the UTM coordinate system format is shown in the form of an M×N matrix, and a plurality of cells constituting the UTM coordinate system format are shown using column numbers and row numbers of the matrix. In FIG. 1(b), the internal structure of the UTM coordinate system format is a 10×6 matrix consisting of row 0 and column 0 to row 9 and column 5. Each cell constituting the matrix is given a cell number using the number of the corresponding row and the number of the corresponding column. For example, (3, 5) 104 denotes elevation data of a cell at row 3 and column 5, and (6, 5) 105 denotes elevation data of a cell at row 6 and column 5.

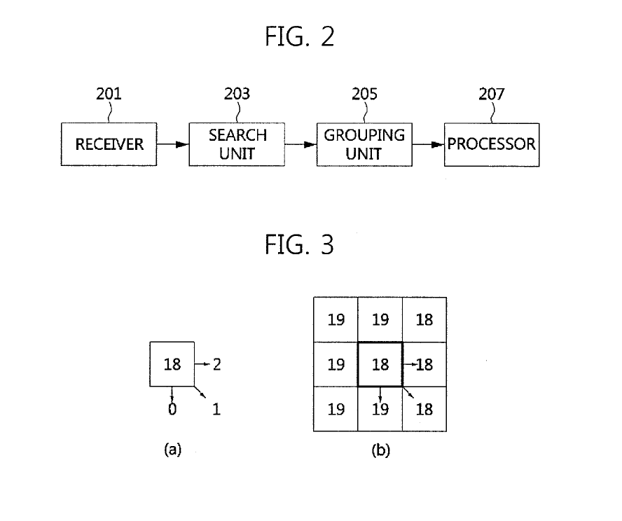

FIG. 2 generally shows an internal structure of an apparatus for downsizing surface elevation data according to an example embodiment of the present invention.

A receiver 201 receives surface elevation data in the form of a matrix consisting of a plurality of cells. Elevation data has been described in detail with reference to FIG. 1, and detailed description thereof will be omitted.

A search unit 203 receives the surface elevation data from the receiver 201, and sets a boundary region to be recognized not to have the same elevation data as a nearby cell on the basis of the surface elevation data. The search unit 203 may conduct a search using the following methods. First, the search unit 203 may conduct a search using a one-cell shift method of setting one boundary region by searching cells one by one in sequence. In the one-cell shift method, data of a predetermined reference elevation value or more is compared with data of nearby cells, and the corresponding cell is set as a boundary region when there is a nearby cell having elevation data that is not the same as the cell.

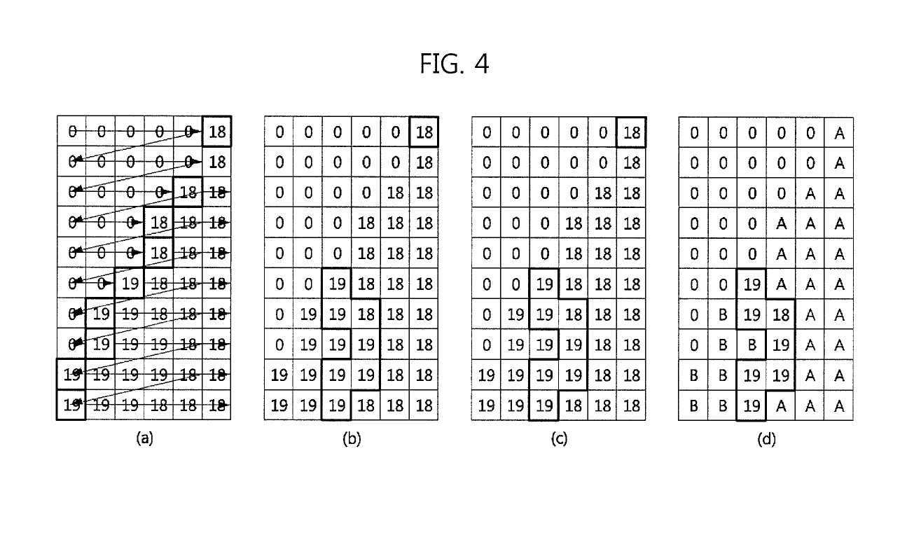

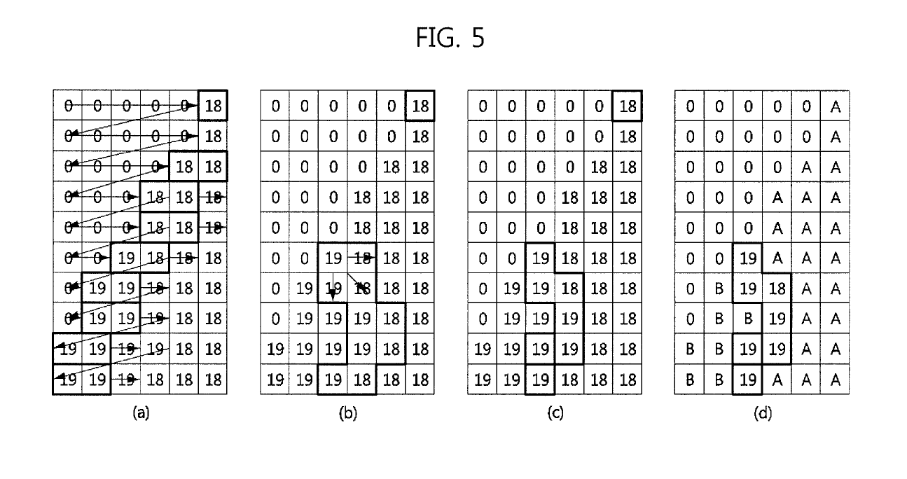

Second, the search unit 203 may conduct a search using a two-cell shift method of setting two boundary regions by searching cells one by one in sequence. The two-cell shift method is the same as the one-cell shift method except that two boundary regions are set. Thus, when a current cell is a last column of a row being searched, the search is started again on the next row. Also, data of a predetermined reference elevation value or more is compared with data of nearby cells, and when there is a nearby cell having elevation data that is not the same as the corresponding cell, the cell having the elevation data of the predetermined reference elevation value or more and a right cell of the cell are set as boundary regions. The one-cell shift method and the two-cell shift method will be described in further detail later with reference to FIGS. 4 and 5.

A grouping unit 205 receives the boundary region searched for using one of the two methods by the search unit 203, and groups pieces of the same elevation data centered on the boundary region. The processor 207 performs triangulation on the basis of the grouping results.

FIG. 3 illustrates a method for a search unit of an apparatus for downsizing surface elevation data to compare data of a cell equal to or greater than a predetermined reference elevation value with data of nearby cells according to an example embodiment of the present invention.

Referring to FIG. 3, the search unit 203 scans cells in a horizontal direction beginning with a first cell. When a cell having elevation data is searched for the first time, the search unit 203 determines whether elevation data of a lower cell, a diagonal cell, and a right cell of the cell is the same as the elevation data, for example, “18,” of the center cell.

As the comparison result, the search unit 203 determines that the elevation data of the center cell is not the same as the elevation data of the lower cell of the center cell, and thus does not store a matrix index of the lower cell. Subsequently, the search unit 203 determines that the elevation data of the center cell is the same as the elevation data of the diagonal cell of the center cell as the comparison result and stores a matrix index of the diagonal cell, and then determines that the elevation data of the center cell is the same as the elevation data of the right cell of the center cell as the comparison result and stores a matrix index of the right cell. Thus, in FIG. 3, the search unit 203 determines the diagonal cell and the right cell as cells having the same elevation data “18” as the reference cell.

FIG. 4 illustrates an example of a process in which a search unit of an apparatus for downsizing surface elevation data performs downsizing using the one-cell shift method according to a first example embodiment of the present invention.

Referring to FIG. 4, the search unit 203 may search for the same adjacent data using the one-cell shift method. The search unit 203 scans a 10×6 matrix in a horizontal direction beginning with a cell (0, 0) of a first row, thereby determining whether elevation data is present. Here, when elevation data is “0,” the search unit 203 determines that no elevation data is present and searches a cell adjacent in the horizontal direction for elevation data.

In FIG. 4(a), the search unit 203 searches a cell (0, 5) in which elevation data “18” is present for the first time, and then sequentially searches a lower cell (1, 5), a diagonal cell (not present), and a right cell (not present) around the cell (0, 5). The search unit 203 checks that elevation data of the lower cell (1, 5) of the cell (0, 5) is “18,” and determines that the elevation data of the cell (0, 5) is the same as that of the cell (1, 5).

When scanning of the first row is completed, the search unit 203 scans a second row in the horizontal direction beginning with a cell (1, 0) to determine whether elevation data is present. When elevation data is present while the search unit 203 scans the second row in the horizontal direction beginning with the cell (1, 0), the search unit 203 searches a lower cell, a diagonal cell, and a right cell around the corresponding cell in sequence to determine whether the nearby cells have the same elevation data as the corresponding cell, like in the first row. The search unit 203 repeatedly performs such a process until scanning of a last row is completed.

During such a process, the search unit 203 completes scanning of a fifth row and scans a sixth row beginning with a cell (5, 0) in the horizontal direction. At this time, the search unit 203 searches a cell (5, 2) in which elevation data “19” is present for the first time, and then searches a lower cell (6, 2), a diagonal cell (6, 3), and a right cell (5, 3) around the cell (5, 2) in sequence. The search unit 203 checks that elevation data of the lower cell (6, 2) of the cell (5, 2) is “19,” and determines that the elevation data of the cell (5, 2) is the same as that of the cell (6, 2).

Subsequently, the search unit 203 checks that elevation data of the diagonal cell (6, 3) of the cell (5, 2) is “18,” and determines that the elevation data of the cell (5, 2) is not the same as that of the diagonal cell (6, 3) of the cell (5, 2). For this reason, the cell (5, 2) is set as a boundary region and recognized to have different elevation than the nearby cell. By repeatedly performing such a process, the search unit 203 may determine a boundary region as shown in FIG. 4(b). The grouping unit 205 receiving the search results of the search unit 203 stores cells of the boundary region of FIG. 4(c), and masks cells having the same elevation data “18” as “A” and cells having the same elevation data “19” as “B.” as shown in FIG. 4(d).

FIG. 5 illustrates an example of a process in which a search unit of an apparatus for downsizing surface elevation data performs downsizing using the two-cell shift method according to a second example embodiment of the present invention.

Referring to FIG. 5, the search unit 203 may search for the same adjacent data using the two-cell shift method. The search unit 203 scans a 10×6 matrix in a horizontal direction beginning with a cell (0, 0) of a first row, thereby determining whether elevation data is present. Here, when elevation data is “0,” the search unit 203 determines that no elevation data is present and searches a cell adjacent in the horizontal direction for elevation data.

In FIG. 5(a), the search unit 203 searches a cell (0, 5) in which elevation data “18” is present for the first time, but cannot apply the two-cell shift method because the cell (0, 5) is a last column of the first row. Thus, the search unit 203 scans a second row in the horizontal direction beginning with a cell (1, 0) to determine whether elevation data is present. The search unit 203 scans the second row in the horizontal direction beginning with the cell (1, 0) to search a cell (1, 5) in which elevation data “18” is present for the first time, but cannot apply the two-cell shift method because the cell (1, 5) is a last column of the second row. Thus, the search unit 203 scans a third row in the horizontal direction beginning with a cell (2, 0) to determine whether elevation data is present.

The search unit 203 scans the third row in the horizontal direction beginning with the cell (2, 0) to search a cell (2, 4) in which elevation data “18” is present for the first time. Since the cell (2, 4) in which the elevation data “18” is found for the first time is not a last cell, the search unit 203 searches a right cell (2, 5) of the cell (2, 4) for elevation data to determine whether or not the searched elevation data is the same as the elevation data of the cell (2, 4). The search unit 203 checks that the elevation data of the right cell (2, 5) of the cell (2, 4) is “18,” and determines that the elevation data of the cell (2, 4) is the same as that of the cell (2, 5).

The search unit 203 repeatedly performs such a process on fourth and fifth rows as well as the third row. Subsequently, the search unit 203 scans a sixth row in the horizontal direction beginning with a cell (5, 0) to search a cell (5, 2) in which elevation data “19” is present for the first time. Since the cell (5, 2) in which the elevation data “19” is found for the first time is not a last cell, the search unit 203 searches a right cell (5, 3) of the cell (5, 2) for elevation data to determine whether or not the elevation data of the right cell (5, 3) is the same as that of the cell (5, 2).

At this time, if it was checked that the elevation data of the right cell (5, 3) of the cell (5, 2) is “19,” the search unit 203 would determine that the elevation data of the cell (5, 2) is the same as that of the cell (5, 3). However, the search unit 203 checks that that elevation data of the right cell (5, 3) of the cell (5, 2) is “18,” thus determining that the elevation data of the cell (5, 2) is not the same as that of the cell (5, 3). In this case, the search unit 203 searches a lower cell, a diagonal cell, and the right cell around the cell (5, 2) in sequence, thereby determining whether elevation data of the nearby cells is the same as that of the cell (5, 2).

More specifically, the search unit 203 searches the lower cell (6, 2), the diagonal cell (6, 3), and the right cell (5, 3) around the cell (5, 2) in sequence. The search unit 203 checks that elevation data of the lower cell (6, 2) of the cell (5, 2) is “19” to determine that the elevation data of the cell (5, 2) is the same as the elevation data of the lower cell (6, 2), and checks that elevation data of the diagonal cell (6, 3) of the cell (5, 2) is “18” to determine that the elevation data of the cell (5, 2) is not the same as the elevation data of the diagonal cell (6, 3). For this reason, the cell (5, 2) is set as a boundary region and recognized to have different elevation than the nearby cell. The search unit 203 repeatedly performs such a process until scanning of a last row is completed, thereby determining a boundary region as shown in FIG. 5(b).

The search unit 203 determines a final boundary region using six boundary regions obtained through a first search process. To this end, the search unit 203 generates subsets by paring two cells having a row difference of 1 among the six boundary regions obtained through the first search process. The subsets are {the cell (5, 2), the cell (6, 2)}, {the cell (5, 2), the cell (6, 3)}, {the cell (6, 2), a cell (7, 3)}, {the cell (6, 3), the cell (7, 3)}, {the cell (7, 3), a cell (8, 3)}, and {the cell (8, 3), a cell (9, 2)}.

The search unit 203 calculates column differences of the generated subsets, and determines that no cell is added as a boundary region when a column difference is 0. On the other hand, when a calculated column difference of a generated subset is +1 or −1, the search unit 203 determines that a cell is added as a boundary region.

First, the subsets {the cell (5, 2), the cell (6, 2)}, {the cell (6, 3), the cell (7, 3)}, and {the cell (7, 3), the cell (8, 3)} have a column difference of 0, and thus no boundary cell is added. On the other hand, the subsets {the cell (5, 2), the cell (6, 3)} and {the cell (6, 2), the cell (7, 3)} have a column difference of −1, and thus a cell obtained by subtracting 1 from a column value of the second cell (6, 3) of the subset needs to be added as a boundary region. At this time, when the cell to be added has already been set as a boundary region, it does not need to be added.

Also, in the subset {the cell (8, 3), the cell (9, 2)}, respective column values are 3 and 2, and the column difference is +1. In this case, a cell (8, 2) obtained by subtracting 1 from a row value of the second cell (9, 2) of the subset is added as a boundary cell. By repeatedly performing such a process, the search unit 203 determines boundary regions as shown in FIG. 5(c), and the grouping unit 205 receiving the search results of the search unit 203 groups cells having the same elevation data “18” as “A” and cells having the same elevation data “19” as “B” as shown in FIG. 5(d).

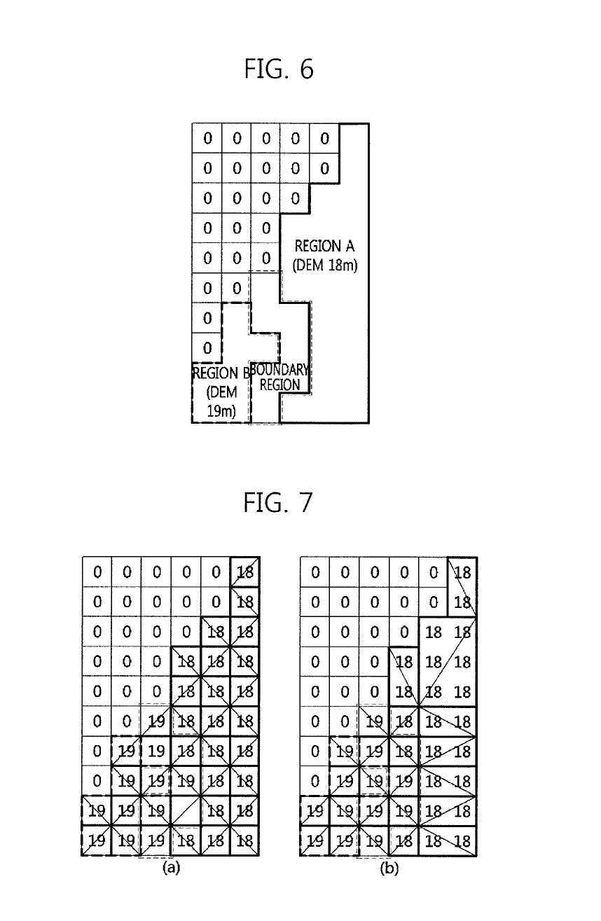

FIG. 6 illustrates results of grouping centered on a boundary region by a grouping unit of an apparatus for downsizing surface elevation data according to an example embodiment of the present invention.

Referring to FIG. 6, the grouping unit 205 groups the same elevation data on the basis of results that the search unit 203 obtains using the one-cell shift method of FIG. 4 or the two-cell shift method of FIG. 5. On the basis of the results of the search unit 203, the grouping unit 205 groups the same elevation data on the right side of the boundary region as region A, and the same elevation data on the left side of the boundary region as region B. In this way, as the results that the grouping unit 205 obtains by grouping the same elevation data, cells having elevation data are reconfigured as shown in FIG. 6.

FIG. 7 illustrates results of triangulation performed by a processor of an apparatus for downsizing surface elevation data according to an example embodiment of the present invention.

Referring to FIG. 7, the processor 207 may perform triangulation on the basis of grouping results of the grouping unit 205. FIG. 7(a) shows results of triangulation performed by the processor 207 on the basis of raw data that has not gone through the grouping unit 205, and FIG. 7(b) shows results of triangulation performed by the processor 207 on the basis of grouping results of the grouping unit 205.

Comparing the results of FIGS. 7(a) and 7(b), it is noted that FIG. 7(a) has a smaller number of triangles, that is, potential reflective objects, resulting from triangulation than FIG. 7(b). Compared to the case of FIG. 7(a) in which the grouping unit 205 performs triangulation on the basis of raw data that has not gone through the grouping unit 205, in the case of FIG. 7(b) in which the grouping unit 205 performs triangulation on the basis of results that the grouping unit 205 obtains by performing grouping, the number of reflective objects to be considered is relatively small, and thus analysis speed increases.

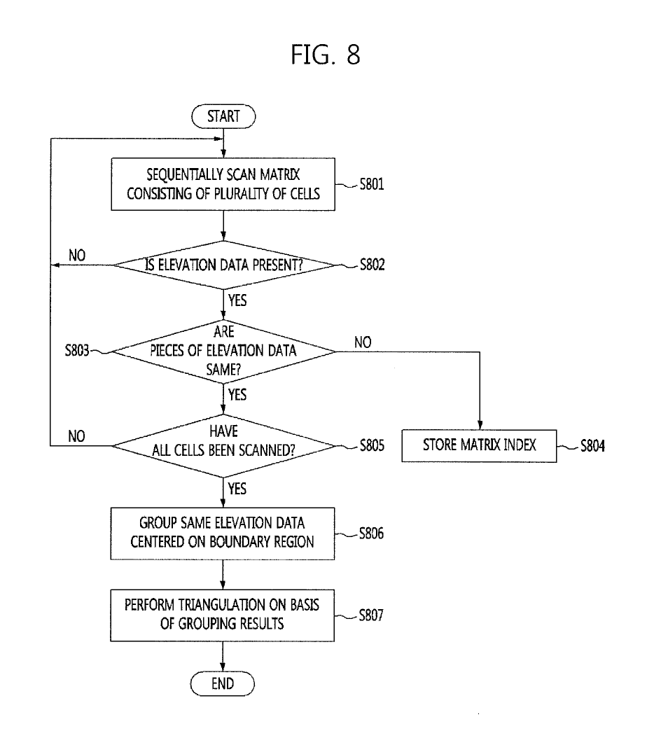

FIG. 8 is a flowchart illustrating a method of downsizing surface elevation data according to an example embodiment of the present invention.

Referring to FIG. 8, an apparatus for downsizing surface elevation data receives elevation data in the form of a matrix consisting of a plurality of cells, and scans the received matrix beginning with a first cell and ending with a last cell (S801). The apparatus for downsizing surface elevation data determines whether a cell that is currently scanned has elevation data of a predetermined reference elevation value or more (S802). When it is determined that the cell has elevation data of the predetermined reference elevation value or more, the apparatus for downsizing surface elevation data compares the data of the cell with data of nearby cells and determines whether a nearby cell has elevation data that is not the same as that of the cell (S803). When it is determined that a nearby cell has elevation data that is not the same as that of the cell, the apparatus for downsizing surface elevation data stores a matrix index of the cell (S804).

The apparatus for downsizing surface elevation data determines whether all the cells included in the matrix have been scanned (S805). When not all the cells have been scanned, the apparatus for downsizing surface elevation data performs such a process again.

After scanning is finished, the apparatus for downsizing surface elevation data sets a matrix index of the corresponding cell as a boundary region, groups the same elevation data centered on the reference region (S806), and performs triangulation on the basis of the grouping results (S807).

When an apparatus and method for downsizing surface elevation data according to example embodiments of the present invention are used, pieces of the same elevation data among pieces of high-resolution surface elevation data used in an outdoor environment are grouped as one. Thus, it is possible to carry out efficient analysis and improve analysis speed.

While the example embodiments of the present invention and their advantages have been described in detail, it should be understood that various changes, substitutions and alterations may be made herein without departing from the scope of the invention.

What is claimed is:

1. A method of downsizing surface elevation data, comprising:
receiving surface elevation data consisting of a plurality of cells, sequentially searching all the cells in a predetermined direction, comparing data of a cell having a predetermined reference elevation value or more with data of nearby cells, and setting the cell as a boundary region when there is a nearby cell having different elevation data than the cell; and
grouping cells having the same data centered on the cell set as the boundary region, and performing triangulation on the basis of the grouping results.

2. The method of claim 1, wherein setting the cell as the boundary region further includes storing a matrix index of the cell when there is the nearby cell having different elevation data than the cell.

3. The method of claim 1, wherein the nearby cells include a lower cell, a lower-right diagonal cell, and a right cell of the cell.

4. The method of claim 1, wherein setting the cell as the boundary region includes searching the cells one by one in sequence to set the boundary region on the basis of one cell or two cells.

5. The method of claim 4, wherein, when the boundary region is set on the basis of two cells, setting the cell as the boundary region includes extracting matrix indices of two cells having a row difference of 1 from matrix indices of a plurality of cells set as the boundary region to generate a subset, and setting a final boundary region on the basis of the subset.

6. The method of claim 5, wherein setting the final boundary region on the basis of the subset includes, when matrix indices of two cells of the subset have a column difference of 1 or −1, calculating and adding a cell corresponding to an additional boundary region according to the column difference value.

7. An apparatus for downsizing surface elevation data, comprising:
a search unit configured to sequentially search all cells in a predetermined direction on the basis of received surface elevation data consisting of the plurality of cells, compare data of a cell having a predetermined reference elevation value or more with data of nearby cells, and set the cell as a boundary region when there is a nearby cell having different elevation data than the cell;
a grouping unit configured to group the same elevation data centered on the boundary region; and
a processor configured to perform triangulation on the basis of the grouping results.

8. The apparatus of claim 7, wherein the search unit stores a matrix index of the cell when there is the nearby cell having different elevation data than the cell.

9. The apparatus of claim 7, wherein the nearby cells include a lower cell, a lower-right diagonal cell, and a right cell of the cell.

10. The apparatus of claim 7, wherein the search unit searches the cells one by one in sequence to set the boundary region on the basis of one cell or two cells.

11. The apparatus of claim 10, wherein, when the boundary region is set on the basis of two cells, the search unit extracts matrix indices of two cells having a row difference of 1 from matrix indices of a plurality of cells set as the boundary region to generate a subset, and calculates and adds a cell corresponding to an additional boundary region for matrix indices of two cells of the subset having a column difference of 1 or −1.
